(19) United States
(12) Patent Application Publication
(10) Pub. No.: US 2026/0314852 A1
(43) Pub. Date: Oct. 15, 2026

(54) MODULAR MERCHANDISING AND DISPLAYING ARRANGEMENT

(71) Applicant: Winston Products LLC, Cleveland, OH (US)

(72) Inventors: Jesse Paradis, North Royalton, OH (US); Jeffery Michael Davis, Solon, OH (US)

(21) Appl. No.: 19/644,137

(22) Filed: Apr. 10, 2026

Related U.S. Application Data
(60) Provisional application No. 63/787,097, filed on Apr. 11, 2025.

(51) Int. Cl. A47F 5/10; A47F 7/00

(52) U.S. Cl. CPC A47F 5/105; A47F 7/0021

(57) ABSTRACT

A modular display includes a frame having a first rail and a second rail, wherein the second rail is spaced from the first rail in a first direction, and a first support member removably supported by and slidable along each of the first and second rails. The first support member includes a pair of slides spaced apart from one another in a second direction, perpendicular to the first direction. The pair of slides are configured to support tow hitch products thereon.

### CROSS-REFERENCE TO RELATED APPLICATIONS

This application claims the benefit of U.S. Provisional Patent Application No. 63/787,097, filed Apr. 11, 2025, which is incorporated herein by reference.

### FIELD OF THE INVENTION

The present invention relates generally to a merchandising and displaying arrangement, and more particularly, a modular display. The modular display includes a frame and a support member removably supported by and slidable along the frame.

### BACKGROUND

Due to their material construction, the typical components used for towing a trailer (ball mounts, hitch balls, couplers, etc.) are very heavy and cumbersome. In a retail setting, this presents a unique problem for the “point of purchase” displaying and merchandising of these products. Conventionally, major retailers of this category merchandise towing products in a horizontally spread or spaced arrangement. Such horizontal presentation is typical for ball mounts.

It is also common for there to be many variations of each component used for towing, including ball mounts, offered for sale in the retail environment. It is difficult for these variations to be distinguished from one another as they all appear similar to the untrained eye and/or are disorganized. Furthermore, these many variations require a significant amount of the available retail space for merchandising and displaying.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

One or more techniques and systems described herein can be utilized to provide a modular display for merchandising and displaying tow hitch products. The display includes a frame having a first rail and a second rail, wherein the second rail is spaced from the first rail in a first direction. A first support member is removably supported by and slidable along each of the first and second rails. The first support member includes a pair of slides spaced apart from one another in a second direction, perpendicular to the first direction, wherein the pair of slides are configured to support the tow hitch products thereon.

In another embodiment, a modular display for merchandising and displaying tow hitch products is provided and includes a frame having a first rail, a second rail, and a pair of side brackets. Each of the first and second rails extends between the pair of side brackets in a first direction, wherein the second rail is spaced from the first rail in a second direction, perpendicular to the first direction. A first support member is removably supported by and slidable along the frame. The first support member includes a tail supported by the first rail, a hanger supported by the second rail, and a pair of slides spaced apart from one another in the first direction. The pair of slides are configured to support the tow hitch products thereon. Each slide of the pair of slides is angled relative to an imaginary horizontal plane that is coterminous with a corresponding front end thereof. Further, a distance between each slide and the imaginary horizontal plane increases at successive points there along in a direction from the first end of the corresponding slide towards an opposite, second end of the corresponding slide. The second end of the corresponding slide is disposed closer to the tail than the first end of the corresponding slide.

### BRIEF DESCRIPTION OF THE DRAWINGS

FIG. 1 is a perspective view of a merchandising display including a frame and first and second support members;

FIG. 2 is a perspective view of the frame depicted in FIG. 1;

FIG. 3 is a perspective, cross-sectional view of the frame taken along the lines 3-3 in FIG. 2;

FIG. 4 is a perspective, cross-sectional view of the frame taken along the lines 4-4 in FIG. 2;

FIG. 5 is a perspective view of the frame attached to a pair of stands and a hanger beam;

FIG. 6 is a cross-sectional view of the frame depicted in FIG. 5 taken along the lines 6-6;

FIG. 7 is an enlarged view of the encircled area depicted in FIG. 6;

FIG. 8 is a perspective view of the first support member;

FIG. 9 is a side view of the first support member;

FIG. 10 is a perspective view of the second support member;

FIG. 11 is a side view of the second support member;

FIG. 12 is a perspective view of the first support member mounted on the frame and being translatable there along;

FIG. 13 is a cross-sectional view of the first support member attached to the frame taken along the lines 13-13 in FIG. 12;

FIG. 14 is a perspective view of the second support member mounted on the frame and being translatable there along;

FIG. 15 is a side view of the second support member attached to the frame;

FIG. 16 is a front view of the merchandising display with exemplary products supported and displayed thereon;

FIG. 17 is a perspective view of a towing ball mount merchandising display arrangement;

FIG. 18 is a side view of a ball mount of the arrangement depicted in FIG. 17;

FIG. 19 is a perspective view of a clamp of the arrangement depicted in FIG. 17;

FIG. 20 is a perspective view of one example locking pin of the arrangement depicted in FIG. 17; and

FIG. 21 is a top view of the arrangement depicted in FIG. 17, including another example of a locking pin.

### DETAILED DESCRIPTION

Conventional merchandising displays include arms of varying dimensions (e.g., lateral width) to accommodate such differing components to be displayed. However, such displays are static in their design in that each arm (or pair of arms) can only support a corresponding (or predetermined) type or configuration of tow hitch component (e.g., ball mounts, hitch balls, etc.) set by the manufacturer without the ability to reconfigure the overall display based on the amount and/or type of components currently in the retailer’s stock. Consequently, the retailer may be required to purchase multiple, differently configured displays to accommodate their inventory, which changes routinely.

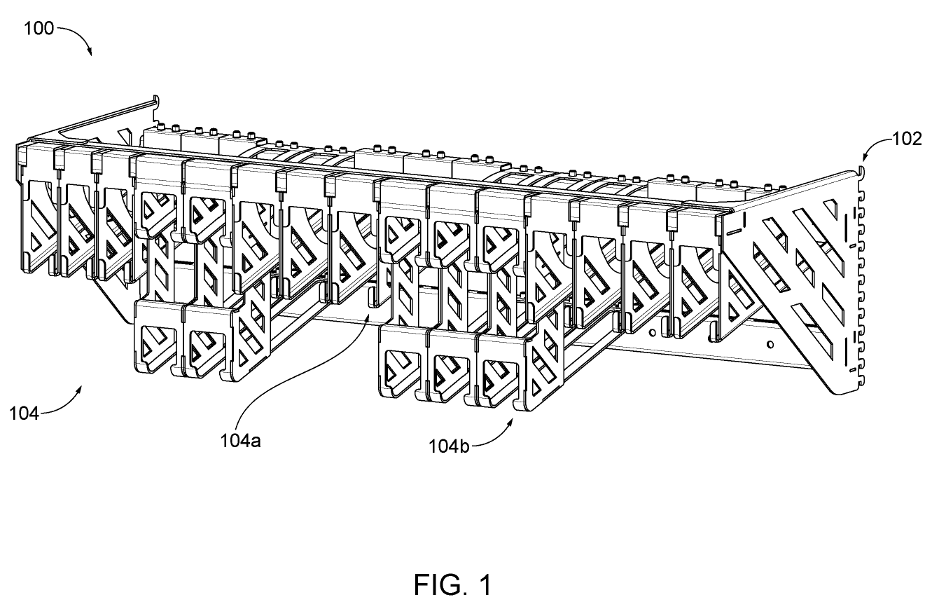

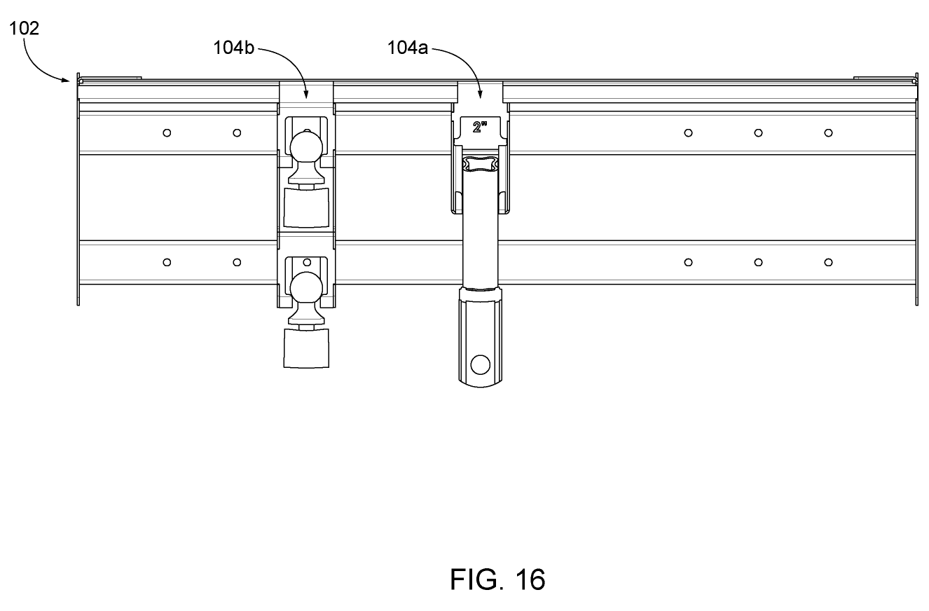

In view of the above, there is a need to provide a merchandising and displaying arrangement having a modular design, where the end purchaser (e.g., store retailer) can adjust the storage configuration (i.e., by moving and/or replacing support members) to suit their needs based on the current inventory they have in stock and desire to display. With reference to FIG. 1, illustrated is a perspective view of a merchandising display 100 configured to house a variety of differently configured products (e.g., ball mounts, hitch balls, etc.) for display (e.g., as shown in FIG. 16, discussed further below). The display 100 includes a frame 102 fixedly attachable to a backing (not show) and which is configured to support at least one support member 104. In the illustrated embodiment, a plurality of support members 104 are shown and include differently configured support members. That is, the plurality of support members 104 includes multiple first support members 104a, and multiple second support members 104b, wherein each first support member 104a is of a single-stack configuration, and wherein each second support member 104b is of a double-stack configuration, as will be described more fully below. Notably, the frame 102 may support any number or combination of support members 104a, 104b permitted by its lateral dimension.

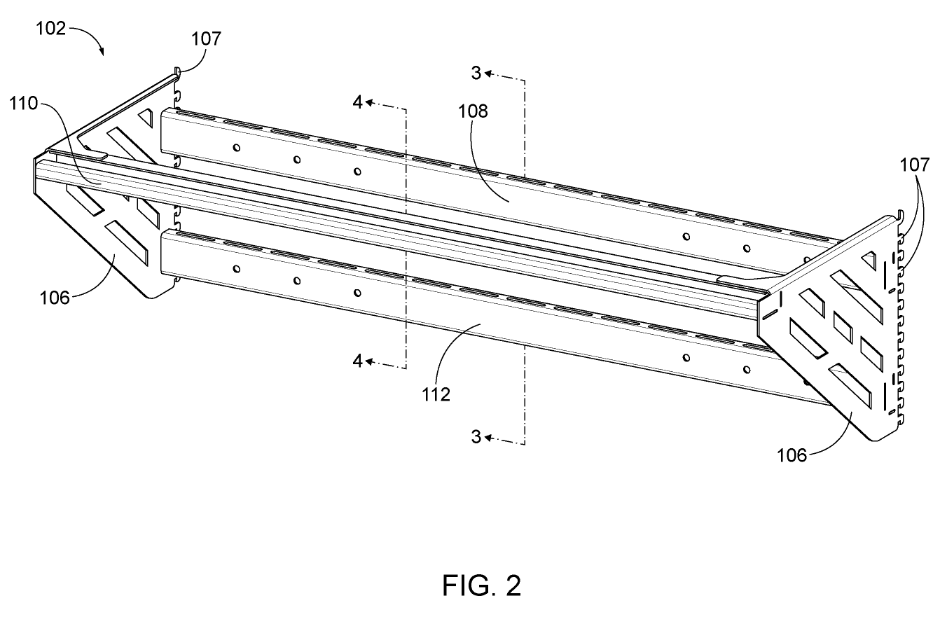

Moving on to FIG. 2, the frame 102 includes a pair of side brackets 106 laterally spaced from one another. In the depicted embodiment, each bracket 106 includes a series of vertically spaced attachment tabs 107 for mounting the frame 102 to the aforementioned backing. In one embodiment, the backing may be a conventional ladder track system or the like, wherein the frame 102 can be removably affixed in a plurality of vertical positions by placing the attachment tabs 107 in corresponding slots in the ladder tracks. In other embodiments, the same type of removable/adjustable attachment can occur between the frame 102 and a display wall, or other type of structure. Still further, in other embodiments, the frame 102 may be attached to the backing in other conventional manners (e.g., fastened directly to a wall via screws, nails, etc.).

As shown, the frame 102 further includes a plurality of rails extending longitudinally between the pair side brackets 106 in a parallel manner (i.e., with respect to one another). More specifically, a first rail 108 is provided at a rear of the frame 102, a second rail 110 is provided at a front of the frame, and a third rail 112 is disposed at the rear of the frame 102 and vertically disposed beneath the first rail 108. Notably, as used herein, the term “rear” is in reference to a portion or end of the frame 102 disposed proximal to the backing when attached thereto, whereas the term “front” is meant to reference an end or portion of the frame 102 distal from the backing. The opposite, lateral ends of the first, second, and third rails 108, 110, 112 can be connected to their respective side bracket 106 via a tongue-in-slot configuration, fasteners (e.g., screws, etc.), adhesives, or other known manners.

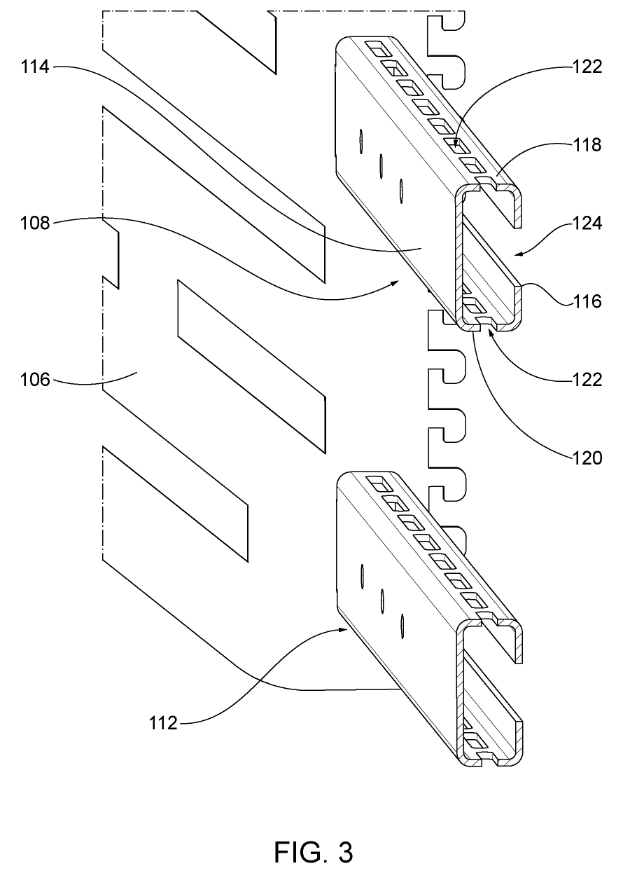

Now with reference to FIG. 3, the first and third rails 108, 112 will be described in detail. It is to be understood that the first and third rails 108, 112 are the same in construction. As such, the below structural description will be made only to the first rail 108 with the understanding that the same description likewise applies to the third rail 112. As shown in FIG. 3, the first rail 108 includes a front wall 114, a rear wall 116, a top wall 118, and a bottom wall 120. These walls 114, 116, 118, 120 can be formed integral with one another (e.g., such that the first rail 108 is an extruded piece-part), or formed separate and distinct from one another and subsequently joined or connected together. The walls 114, 116, 118, 120 are oriented to provide the first rail 108 with a substantially rectangular shape in cross-section, wherein the corners of that rectangular shape are rounded; however, other cross-sectional shapes are contemplated.

Each of the top wall 118 and the bottom wall 120 has a series of slots 122 (e.g., through-holes) formed therein. More specifically, the series of slots 122 formed in the top wall 118 are successively spaced one from the other along the length of the first rail 108 (i.e., in a direction from one of the side brackets 106 towards the other), wherein the slots 122 formed in the bottom wall 120 have the same or similar orientation. More specifically, each slot 122 formed in the top wall 118 is vertically aligned with a corresponding one of the slots 122 formed in the bottom wall 120 such that any corresponding (vertically aligned) pair of slots 122 is essentially coaxial. As will be described more fully below, each corresponding (vertically aligned) pair of slots 122 is configured to receive a corresponding fastener (e.g., screws, bolts, pins, etc.) to removably secure a corresponding support member 104 at a desired location along the length of the frame 102 (i.e., in the lateral direction).

As further shown, a cut-out 124 is formed in the rear wall 116. The cut-out 124 extends continuously along the entire length of the first rail 108 in the lateral direction (i.e., in the direction from one of the side brackets 106 towards the other). However, it is contemplated that the cut-out 124 need not extend along the entire length of the first rail 108 and/or extend there-along in a continuous manner. For example, a plurality of cut-outs 124 may be formed in the rear wall 116 that are successively spaced one after another along the length of the first rail 108.

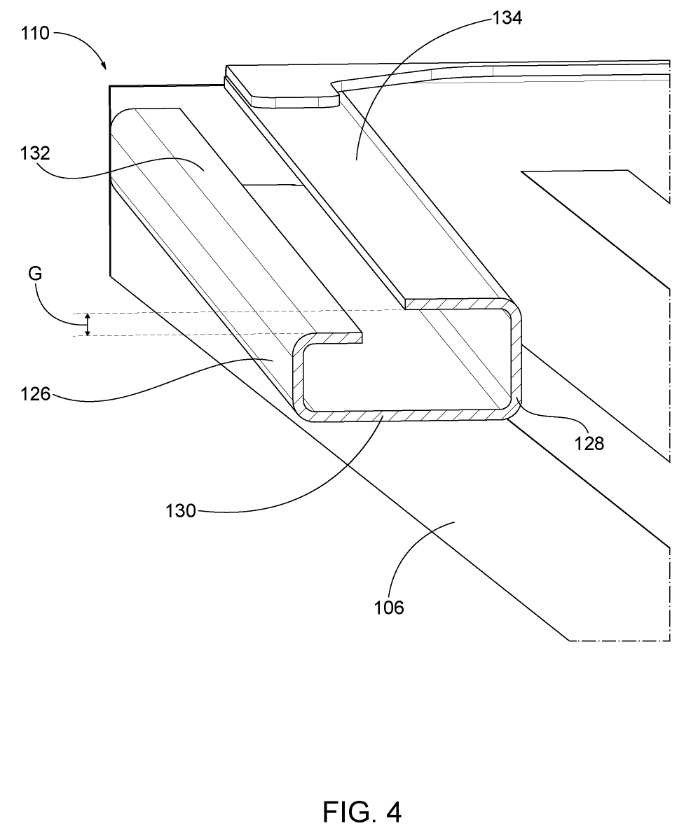

Now with reference to FIG. 4, the second rail 110 is shown in a perspective, cross-sectional view. Similar to the first rail 108, the second rail 110 likewise includes a front wall 126, a rear wall 128, and a bottom wall 130. Moreover, a support platform 132 projects from an end of the front wall 126 (i.e., an end opposite the bottom wall 130) and extends towards the rear wall 128. Further, an overhang 134 projects from an end of the rear wall 128 (i.e., an end opposite the bottom wall 130) and extends in a direction towards the front wall 126. The aforementioned elements of the second rail 110 can be formed integral with one another (e.g., such that the second rail 110 is an extruded piece-part) or formed separate and distinct from one another and subsequently joined or connected together. In the illustrated embodiment, the bottom wall 130, platform 132, and overhang 134 are all planar and parallel relative to one another. However, it is contemplated that any one of these elements may be provided at an angle relative to the others.

As further shown, a vertical distance (or height) of the rear wall 128 is greater than that of the front wall 126. As such, the platform 132 and the overhang 134 are not coplanar. Rather, the overhang 134 is provided a vertical distance from the bottom wall 130 that is greater than a corresponding vertical distance of the platform 132 (i.e., relative to the bottom wall 130). As such, a vertical gap ‘G’ is provided between the platform 132 and the overhang 134 to permit clearance for the second rail 110 to receive a hanger of a support member 104, as will be discussed in greater detail below. Moreover, in the illustrated embodiment, the platform 132 and the overhang 134 do not overlap in the vertical direction. However, it is contemplated in other embodiments that the platform 132 and the overhang 134 can overlap in the vertical direction.

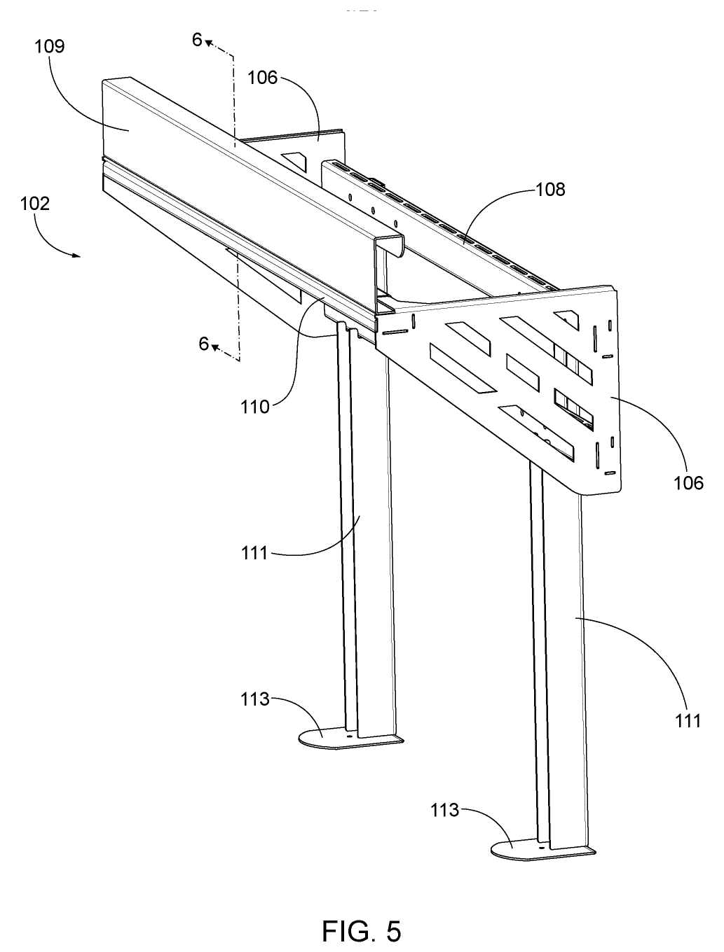

As mentioned above, the frame 102 depicted in FIG. 2 can be removably connectable to a conventional ladder track system or the like. In yet another embodiment (e.g., as shown in FIGS. 5-7), the frame 102 can be removably attachable to a conventional pallet rack, such as those commonly found in commercial hardware retail stores. As shown in FIG. 5, this alternative embodiment further includes a hanger beam 109 connected to the second rail 110, and a pair of stands 111, each having a corresponding foot 113 provided at an end distal from the first and/or third rail 108, 112. In use, the hanger beam 109 wraps around and is supported by a front-most crossbeam of the pallet rack (not shown) so as to support a front portion of the frame 102. Separately, the stands 111 support the rear portion of the frame 102 on a support surface of the pallet rack (e.g., plywood or the like). The stands 111 can be secured to the pallet rack via fasteners (e.g., bolts, screws, nails, etc.) passing through their respective feet 113 and into the support surface to prevent accidental movement of the stands 111, and thus the frame 102, relative to the support surface.

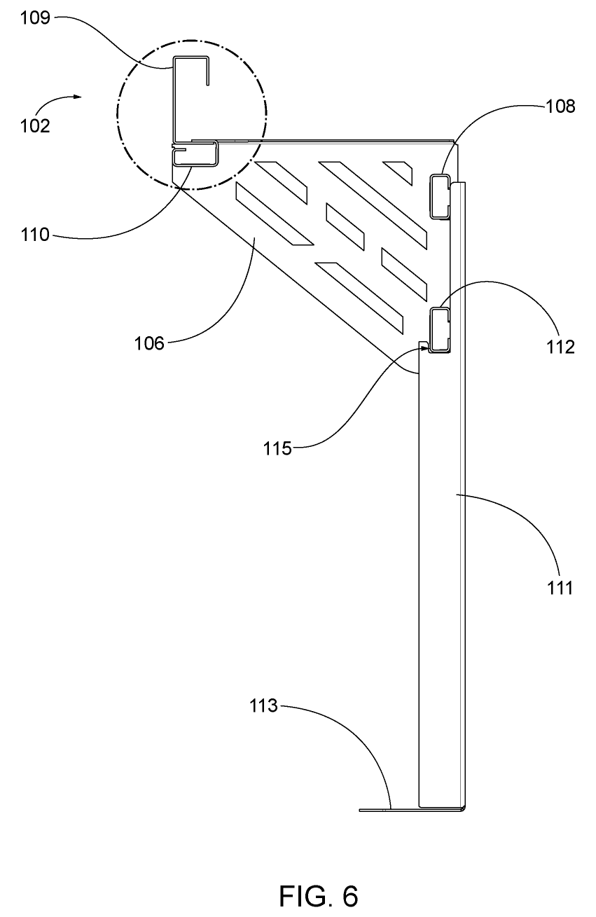

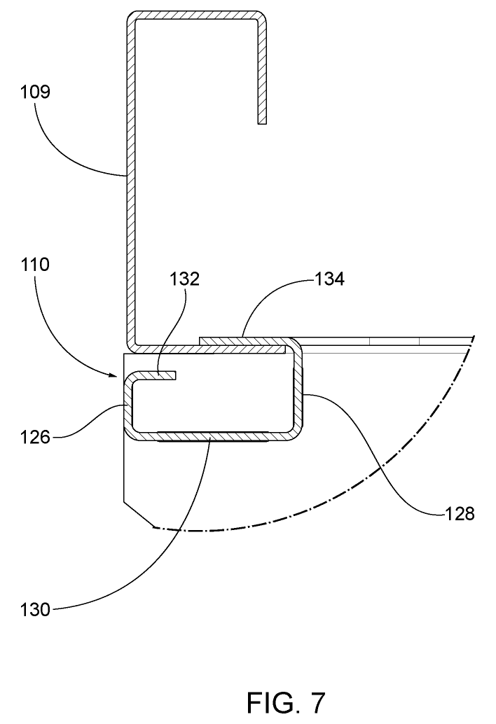

With reference to FIG. 6, each stand 111 includes a hook-shaped cutout or channel 115 that receives and supports the third rail 112 therein. Of note, each of the first and third rails 108, 112 can be fastened to the stands 111 via conventional fasteners (e.g., screws, bolts, etc.) to enhance the structural integrity of the frame 102. Further, with reference to FIG. 7, which is an enlarged image of the area encircled in FIG. 6, the hanger beam 109 can be connected to a surface of the overhang 134 in a non-removable manner (e.g., via welding, soldering, etc.). In other embodiments, the hanger beam 109 can be connected to the overhang 134 via snaps, adhesives, Velcro, or other known attachment means. While the hanger beam 109 is shown attached to a bottom surface of the overhang 134 (i.e., a surface facing the bottom wall 130 of the second rail 110), it is further contemplated that the hanger beam 109 can be attached to a different surface of the overhang 134 (e.g., an opposite, top surface) or even a different wall (e.g., rear wall 128) of the second rail 110.

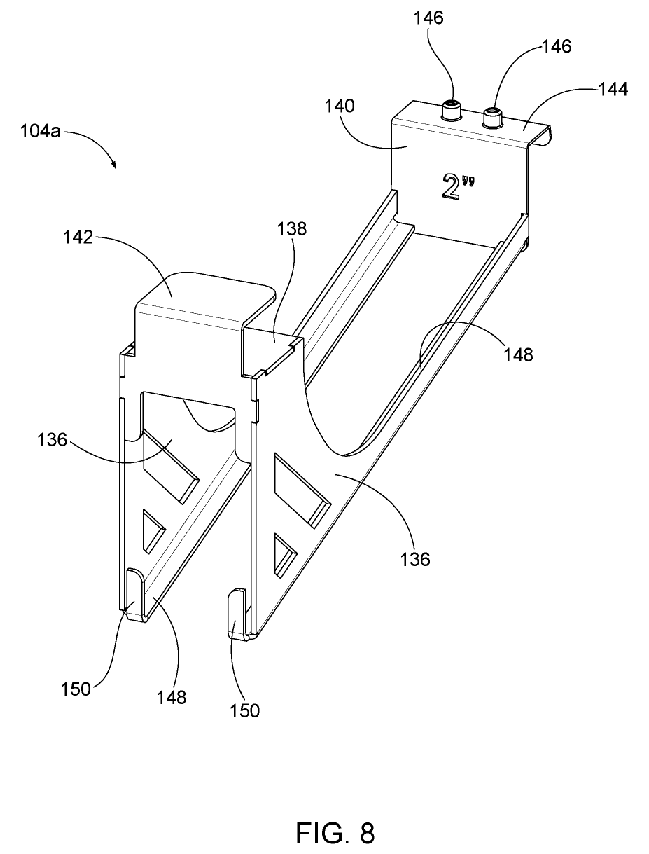

Moving on to FIG. 8, the first support member 104a is shown in a perspective view. The first support member 104a includes a pair of side walls 136 laterally spaced from and connected to one another. More specifically, the side walls 136 are connected to one another at a front portion of the first support member 104a via a top plate 138, and at a rear portion of the first support member 104a via a rear plate 140. Notably, the lateral distance between the side walls 136 may be 1-8 inches, depending on the type of product that particular support member is configured to hold; however other distances in the lateral direction are contemplated. For simplicity, the lateral dimension of the support member may be embossed, cut-out, or otherwise displayed as indicia on the rear plate 140. Moreover, an L-shaped hanger 142 stands proud from the top plate 138 (e.g., at a front edge thereof) and is configured to engage with the second rail 110 for securement thereto, as will be described further below. Further, an L-shaped tail 144 projects from the rear plate 140 (e.g., at a top edge thereof) and is configured to engage with the first rail 108 for securement thereto. Moreover, a pair of fasteners 146 (e.g., nuts) are held captive on the tail 144. That is, the fasteners 146 may be joined to the tail 144 (e.g., via welding, soldering, etc.) in a non-removable manner. Alternatively, the fasteners 146 may be separate from the tail 144. While the illustrated embodiment depicts two fasteners 146, it is to be understood that the tail 144 may have more or less total fasteners 146 joined thereto or associated therewith.

As further shown, each of the side walls 136 has a slide 148 formed at a bottom edge thereof, wherein each slide 148 extends from the rear plate 140 to the front of the first support member 104a. Moreover, a stop 150 is formed at an end of each slide 148 distal from the rear plate 140 and is configured to act as a backstop for the particular product housed and supported by the first support member 104a. More specifically, each stop 150 may be a tab that is formed integral with the corresponding slide 148 and which is provided at an angle relative thereto. For example, the stops 150 may reside on a common, first imaginary vertical plane, and the rear plate 140 may reside on a second imaginary vertical plane, wherein the first and second imaginary vertical planes are parallel. While the stops 150 noted above have been described as integral with their corresponding slides 148, it is to be understood that other configurations are contemplated. For example, each stop 150 may be formed separate and distinct from its corresponding slide 148 and subsequently secured thereto in a removable (e.g., snaps, male and female type connectors, etc.) or non-removable manner (e.g., welding, soldering, etc.). Notably, each slide 148 projects from its corresponding side wall 136 in a direction towards the other side wall 136 such that the slides 148 are configured to support a product thereon (e.g., ball mount, hitch ball, etc.) in a gravity-fed manner, as discussed below.

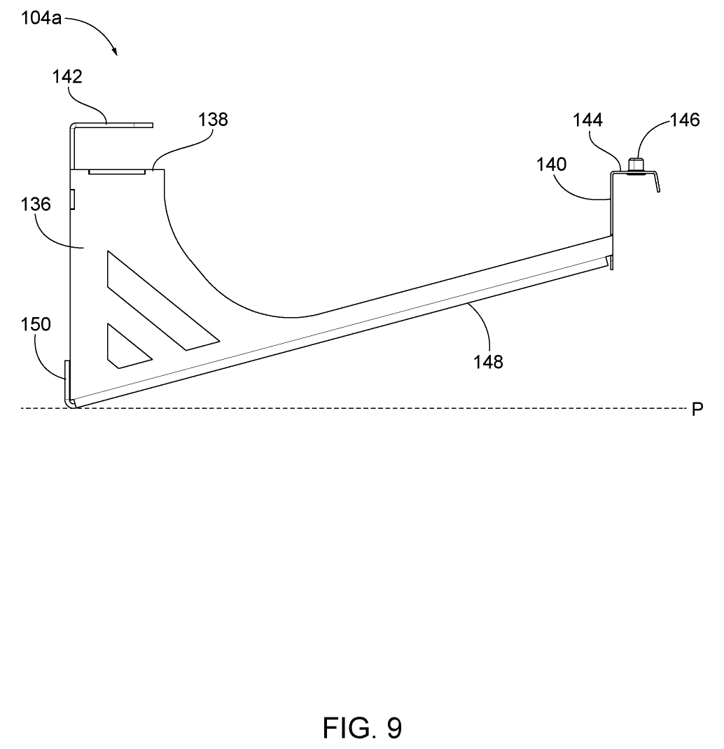

With reference to FIG. 9, the first support member 104a is shown in an assembled state relative to the frame 102, which is not shown for simplicity. As depicted, in the assembled state, each slide 148 continuously inclines in a direction from a front of the first support member 104a towards a rear thereof. That is, each slide 148 is provided at an angle relative to an imaginary horizontal plane ‘P’ that is coterminous with a front-most, bottom edge of each slide 148. Accordingly, a distance between the slide 148 and the imaginary horizontal plane ‘P’ (taken in a direction normal to the imaginary horizontal plane ‘P’) continuously increases at successive points along the slide 148 in a front-to-rear direction of the first support member 104a. Due to this inclination, when a front-most product is removed from the first support member 104a by a prospective purchaser, the immediately adjacent product will be brought to the front of the first support member 104a by gravity and will be held securely against the stops 150 (which hinder/prohibit accidental dislodgement from the slides 148).

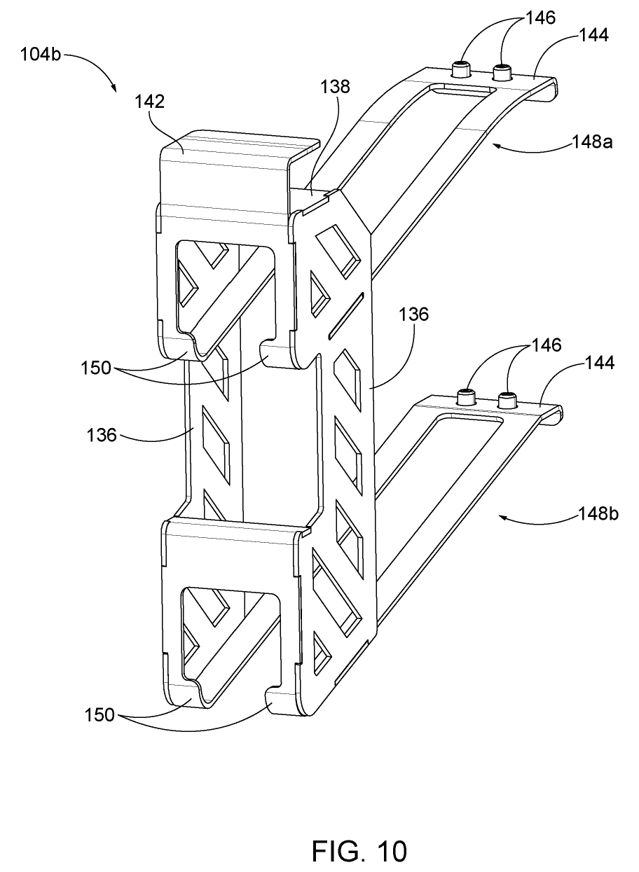

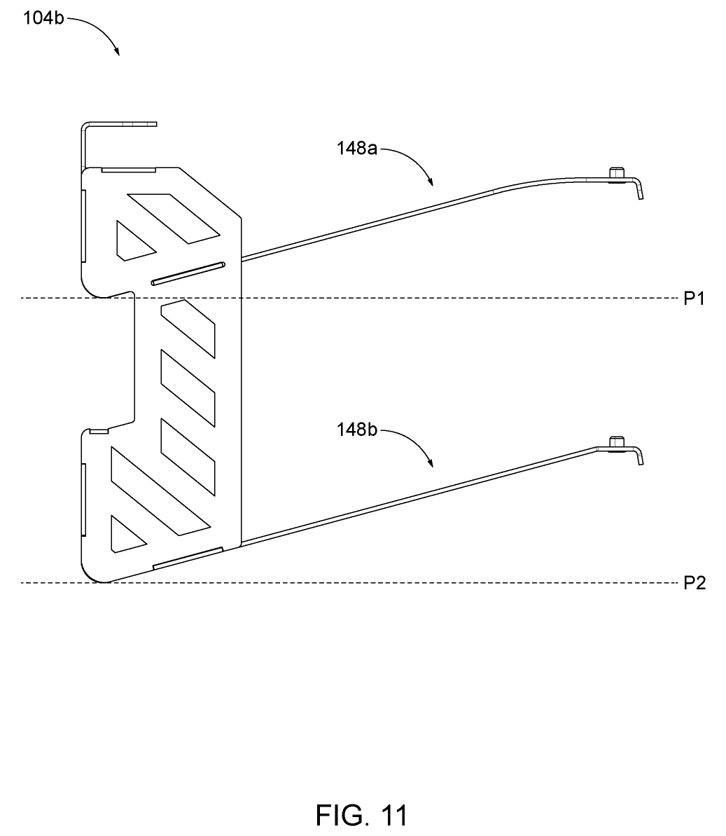

Now moving on to FIGS. 10-11, the second support member 104b is shown in a perspective view and a side view, respectively. Indeed, much of the structural detail of the first support member 104a applies to the second support member 104b. Accordingly, the same or similar reference numerals will be used to designate like parts of the second support member 104b, and only the notable differences will be described in detail for brevity.

With reference to FIG. 10, the second support member 104b includes a first pair of slides 148a vertically disposed above a second pair of slides 148b. Unlike the first support member 104a, the second support member 104b has no rear plate associated with the first or second pair of slides 148a, 148b. Rather a rear end of each slide of the first and second pairs of slides 148a, 148b terminates at its corresponding tail 144. As better shown in FIG. 11, each of the first and second pairs of slides 148a, 148b continuously inclines relative to a corresponding imaginary plane ‘P1,’ ‘P2,’ in the same manner as discussed above. As will be further discussed below, the second support member 104b having first and second pairs of slides 148a, 148b permits housing and displaying of two products on a single support member.

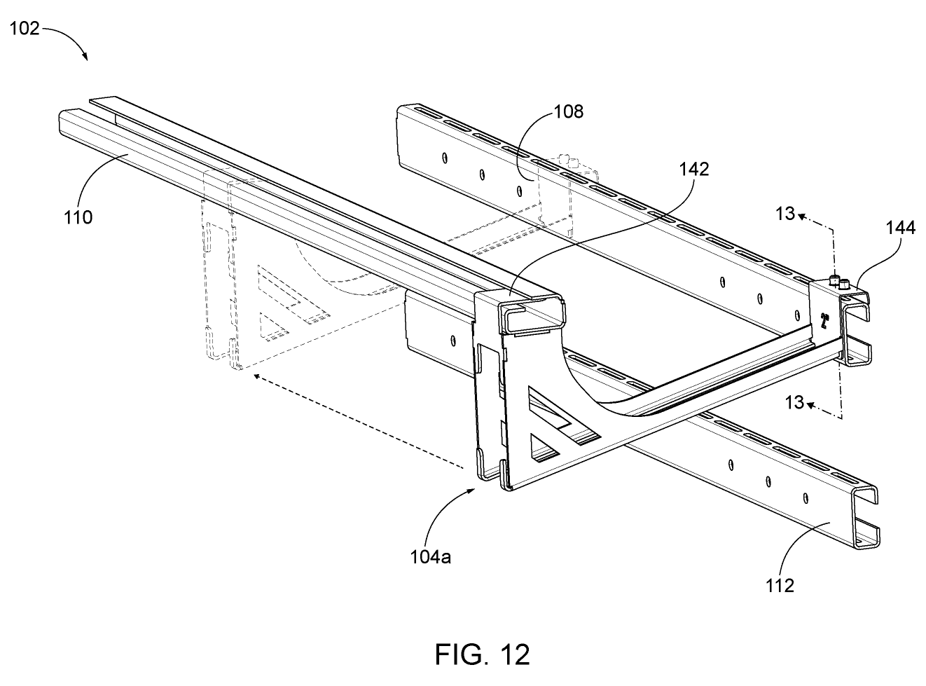

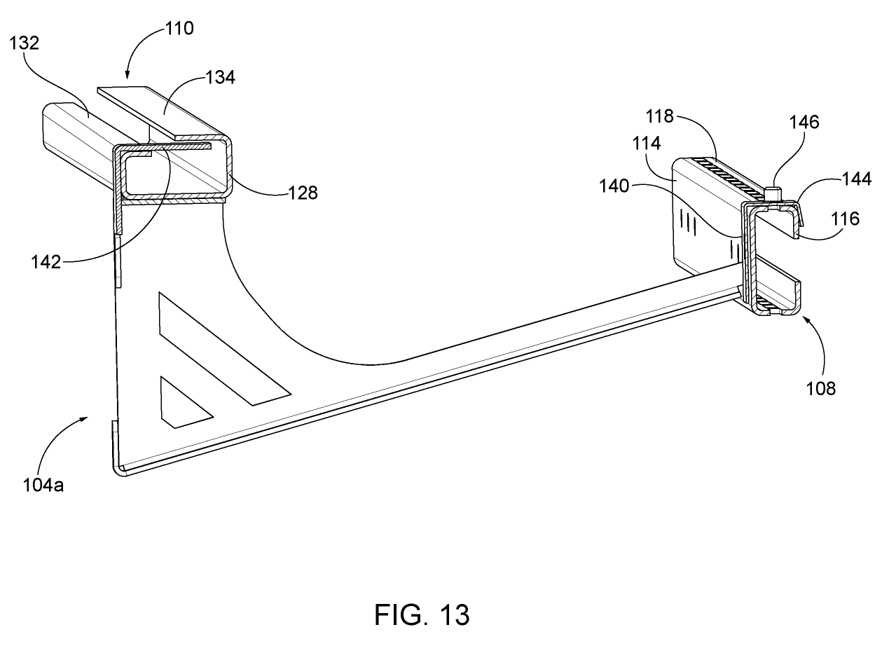

Now moving on to FIGS. 12-13, the first support member 104a is shown in an assembled state on the frame 102, with the side brackets 106 removed for ease of illustration. More specifically, the rear end of the first support member 104a is slidably mounted on (i.e., supported by) the first rail 108 via the tail 144, whereas the front end of the first support member 104a is slidably mounted on (i.e., supported by) the second rail 110 via the hanger 142. As best shown in FIG. 13, in the assembled state, the hanger 142 extends within the vertical gap ‘G’ (i.e., shown in FIG. 4) and is supported by the platform 132. More specifically, the hanger 142 directly rests on and contacts the platform 132 so as to be supported thereby. Moreover, the hanger 142 extends towards the rear wall 128 of the second rail 110 such that the overhang 134 overlaps the hanger 142 in the vertical direction. This overlapping nature provides enhanced support for the first support member 104a during both static placement and lateral translation. More specifically, the vertical overlapping between the overhang 134 and the hanger 142 prohibits the first support member 104a from skewing (and potentially dislodging) relative to the second rail 110 while the first support member 104a is being laterally shifted (i.e., from one lateral position along the frame 102 to another) and/or while the first support member 104a is being loaded with merchandise.

As further shown in FIG. 13, the rear plate 140 is disposed adjacent (e.g., contacting) the front wall 114 of the first rail 108 while the L-shaped tail 144 rests on the top wall 118 of the first rail 108 and wraps around to partially cover the rear wall 116. Accordingly, as the L-shaped tail 144 is provided adjacent to both the top and rear walls 118, 116 of the first rail 108, the first support member 104a is secured in place in the front-to-rear direction, when fully assembled.

To place the first support member 104a on the frame 102, the tail 144 and the hanger 142 are aligned relative to the first and second rails 108, 110, respectively. Thereafter, the first support member 104a can be moved rearwardly, such that the hanger 142 passes through the vertical gap ‘G’ between the platform 132 and the overhang 134, and such that the tail 144 is disposed vertically above the first rail 108. Next, the first support member 104a may be rotated such that the tail 144 contacts and rests on the first rail 108. In the assembled state, the first support member 104a is freely slidable (i.e., translatable) along the first and second rails 108, 110 in the lateral direction (i.e., between the pair of side brackets 106). Notably, to secure the first support member 104a in a desired (lateral) position on the frame 102, a user simply inserts fasteners (e.g., bolts, screws, etc.) through the corresponding pair of (vertically aligned) slots 122 (i.e., aligned with the tail 144) to engage with the corresponding fastener 146 (e.g., nut) on the tail 144. In doing so, the first support member 104a will be held in place on the first rail 108, thereby preventing accidental movement of the first support member 104a in the lateral direction. Further, to move the first support member 104a from a first position on the frame 102 to a second position thereon (e.g., as shown in FIG. 12), the user need only remove the fasteners (e.g., bolts, screws) to permit the first support member 104a to slide along the first and second rails 108, 110. After reaching the second position, the fasteners can be inserted once again to secure the first support member 104a at that location.

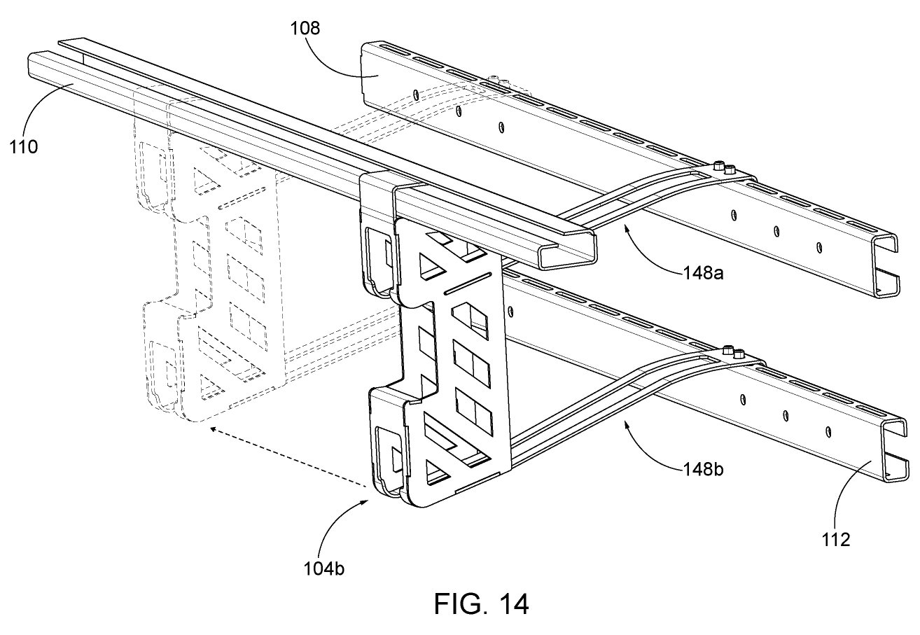

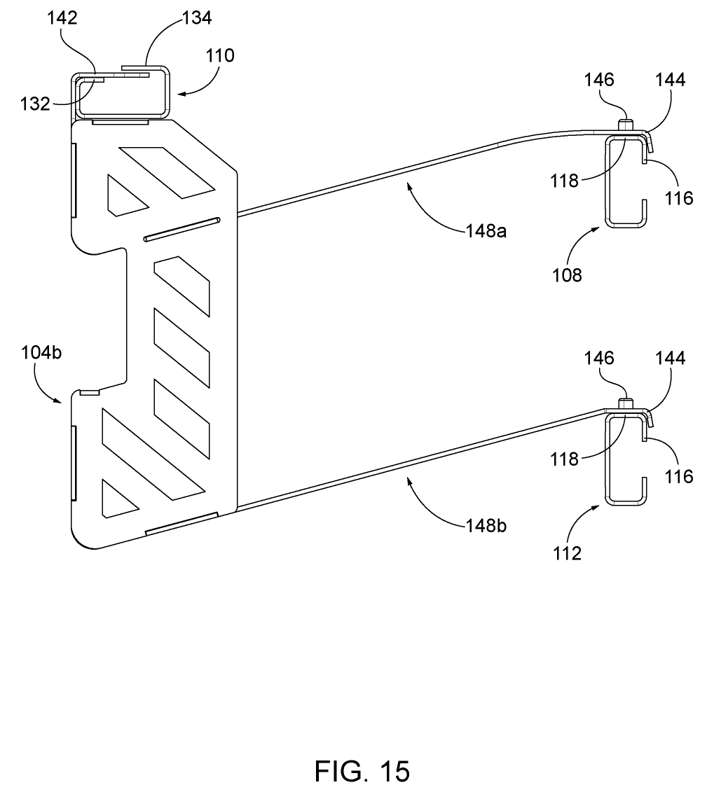

With reference to FIGS. 14-15, the second support member 104b is assembled on (and slidable along) the frame 102 in substantially the same manner as the first support member 104a. However, in this embodiment, the tail 144 associated with the first pair of slides 148a rests on and engages the first rail 108, whereas the tail 144 associated with the second pair of slides 148b rests on and engages the third rail 112. Indeed, each of the tails 144 can be secured to the corresponding first rail 108 and third rail 112 in the same manner noted above so as to secure the second support member 104b in various (distinct) lateral positions along the length of the frame 102.

Accordingly, the aforementioned display 100 permits quick connection/disconnection of the first and second support members 104a, 104b on the frame 102, as well as efficient adjustment of either support member’s placement on the frame 102. With this modular design, the display 100 can quickly be adjusted (i.e., reconfigured) to accommodate a variety of products that the end user (e.g., store retailer) has in stock at any given time. An example of which is shown in FIG. 16, where the first and second support members 104a, 104b are used to display a varying amount and type of products. As shown, the single-stack configuration of the first support member 104a lends itself to support longer products (e.g., such as ball mounts), as it provides adequate clearance to accommodate such products in a hanging orientation. Conversely, the double-stack configuration of the second support member 104b may lend itself to support shorter products (e.g., hitch balls). With this said, it is contemplated that the second support member 104b can be configured to support two different types of products. For example, the first pair of slides 148a of the second support member 104b can support hitch balls thereon, whereas the second pair of slides 148b can support ball mounts thereon.

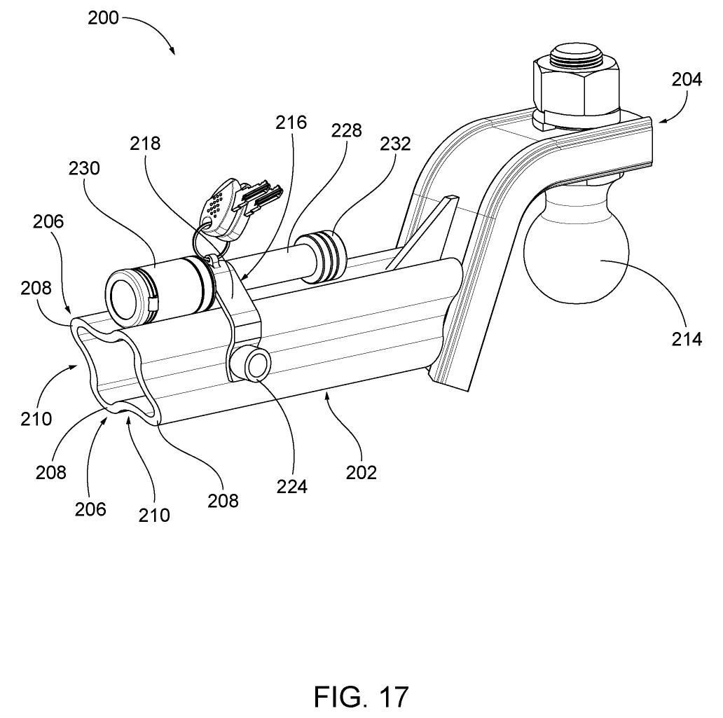

Notably, one such type of product that may be housed on the display 100 is shown in FIGS. 17-21. With reference to FIG. 17, a towing ball mount merchandising display arrangement 200 is shown and includes a ball mount having a mounting tube 202 with a tongue 204 provided at an end thereof. In the illustrated embodiment, the mounting tube 202 has four side walls with a lobe 206 provided at each corner of a pair of adjacent side walls. The lobes 206 have curved surfaces 208, and a depression 210 is defined between an adjacent pair of said lobes 206. These depressions 210 may be used to hold other elements of the towing ball mount while being displayed or in use, as will be described further below.

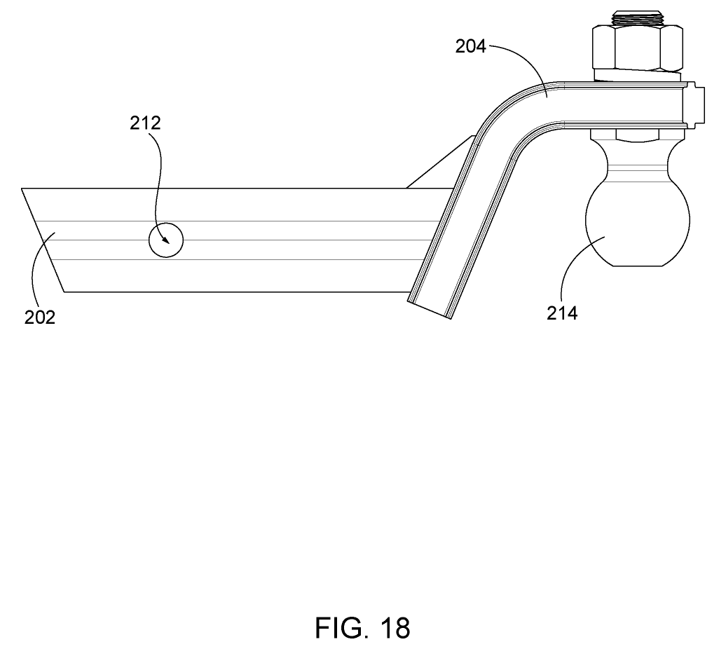

As shown in FIG. 18, an aperture 212 is formed in each side wall of a pair of opposing side walls of the mounting tube 202 such that said apertures 212 formed therein are coaxial. The apertures 212 are dimensioned to receive corresponding protrusions of a clamp, as discussed further below. Notably, while not shown, it is to be understood that the tongue 204 of the ball mount likewise includes an aperture to receive a portion of a hitch ball 214 therein for securement to the ball mount.

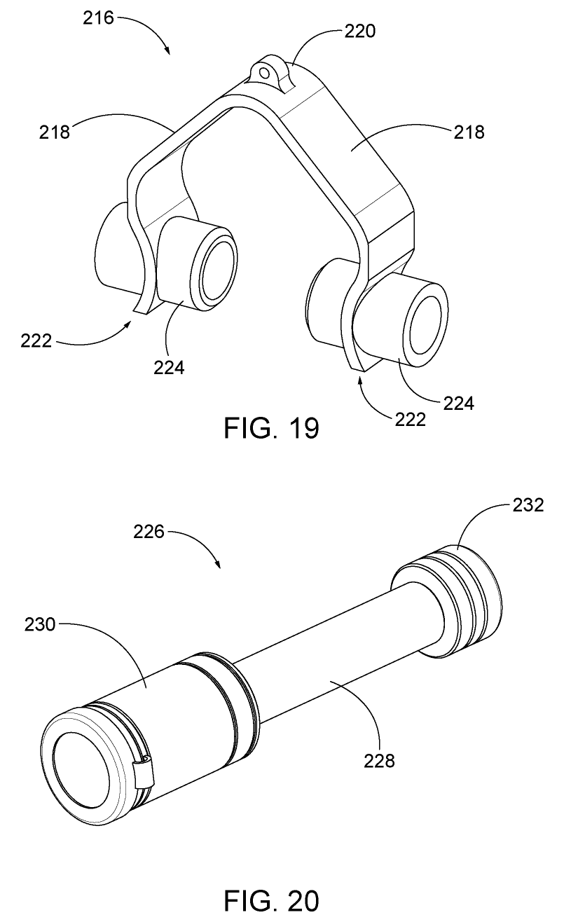

With reference to FIG. 19, the arrangement 200 further includes a clamp 216 configured to secure an accessory (e.g., lock or pin) to the mounting tube 202 during display or use. The clamp 216 has a pair of legs 218 that connect together at a common junction 220, and which extend away therefrom to terminate at respective, distal ends 222. As further shown, each leg 218 includes a protrusion 224 extending outwards and away therefrom. Notably, in the illustrated embodiment, the corresponding protrusion 224 of each leg 218 extends away therefrom in opposite directions. However, it is contemplated that the corresponding protrusion 224 of each leg 218 may extend away therefrom in only a single direction, such that the protrusions 224 project away from their corresponding leg 218 in a direction towards the other protrusion 224.

Moving on to FIG. 20, one example of an accessory is shown as a locking pin 226 configured to secure the mounting tube 202 to a vehicle, in-use. As shown, the locking pin 226 has a body 228 extending between a head 230 and a collar 232. Notably, a diameter of the body 228 is different than corresponding diameters for each of the head 230 and the collar 232. More specifically, the diameter of the body 228 is less than that of each of the head 230 and the collar 232. However, other dimensions of the locking pin 226 are contemplated.

Briefly moving back to FIG. 17, in the assembled state, the locking pin 226 is secured to the mounting tube 202 via the clamp 216. This is achieved by placing the locking pin 226 in a corresponding depression 210 of the mounting tube 202 (i.e., one which is devoid of an aperture 212) and subsequently securing the clamp 216 to the mounting tube 202 by inserting each of the protrusions 224 into a corresponding one of the apertures 212. Notably, the clamp 216 can be made of an elastic material (e.g., thermoplastics) so as to elastically deform to permit installation on and removal from the mounting tube 202. As further shown, the clamp 216 is disposed over the body 228 of the locking pin 226 when installed, so as to be positioned between the head 230 and the collar 232. Due to the dimensional differences between the body 228, the head 230, and the collar 232, the locking pin 226 will be prevented from accidentally disengaging from the mounting tube 202. That is, if the clamping force of the clamp 216 is not sufficient to statically hold the locking pin 226 in place relative to the mounting tube 202, then any movement of the locking pin 226 will be bounded by the head 230 and the collar 232, and thus accidental dislodgment of the locking pin 226 from the mounting tube 202 is prevented.

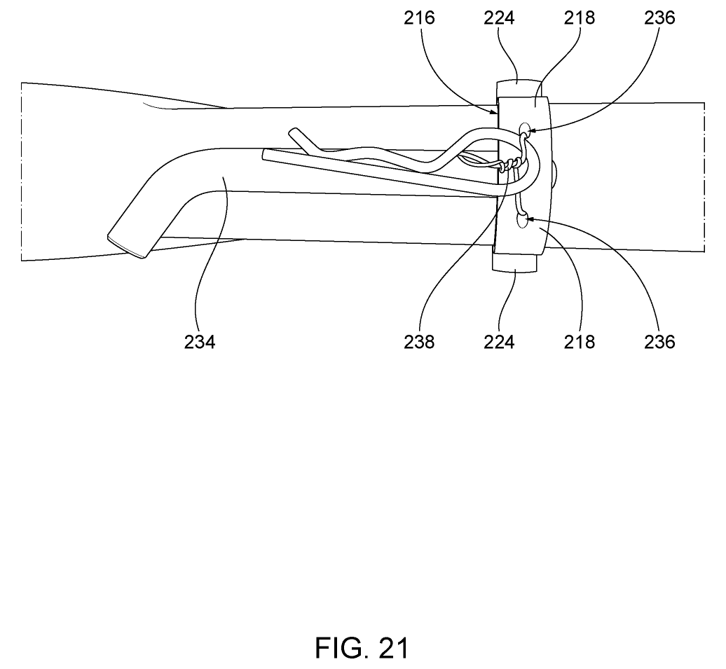

In yet another embodiment, the arrangement 200 can be configured to secure a conventional locking pin 234 thereto. Unlike the previously discussed locking pin 226, some conventional locking pins 234 (e.g., as shown in FIG. 21) do not possess diametric differences along a longitudinal length thereof. Rather, the diameter of the locking pin 234 generally remains constant throughout its length, with one end provided at an angle, and the other end having a through-hole formed therein for receiving a safety pin. In such embodiments, the clamp 216 can include a through-hole 236 formed in each leg 218 for receiving a wire-tie 238 (or the like). More specifically, the wire-tie 238 passes through each of the through-holes 238 formed in the corresponding leg 218 of the clamp 216 as well as the through-hole (not shown) formed in the locking pin 234 and is twisted superjacent the clamp 216 to secure the locking pin 234 thereto.

Notably, in either of the aforementioned embodiments, the external portion of each protrusion 224 (i.e., not received in a corresponding aperture 212 in the assembled state) can act as the engagement point between the arrangement 200 and a corresponding support member 104 when received in the display 100. More specifically, each external portion of the protrusions 224 may be supported by a corresponding one of the slides 148 of the support member 104 in the gravity-fed manner, as discussed above. Accordingly, the clamp 216 not only secures an accessory (e.g., locking pin 226) to the ball mount, but likewise acts as a supporting feature when the arrangement 200 is stocked in the display 100. While the aforementioned embodiment uses the clamp 216 as the engagement feature between the arrangement 200 and the support member 104, it is contemplated that other conventional elements (e.g., hanger pins) may likewise be used, such as those discussed in U.S. Patent No. 8,960,706, the contents of which are wholly incorporated herein by reference.

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A modular display for merchandising and displaying tow hitch products, the display comprising:
a frame having a first rail and a second rail, wherein the second rail is spaced from the first rail in a first direction; and
a first support member removably supported by and slidable along each of the first and second rails, the first support member including a pair of slides spaced apart from one another in a second direction, perpendicular to the first direction, wherein the pair of slides are configured to support the tow hitch products thereon.

2. The modular display of claim 1, the first support member comprising a tail supported by the first rail and a hanger supported by the second rail.

3. The modular display of claim 2, the first rail comprising a top wall and a bottom wall, wherein each of the top wall and the bottom wall has a slot formed therein, wherein the slot formed in the top wall and the slot formed in the bottom wall are coaxial and are configured to receive a first fastener therein.

4. The modular display of claim 3, wherein the first rail further comprises a rear wall, wherein the tail rests on the top wall and extends to an area adjacent to the rear wall.

5. The modular display of claim 3, wherein the tail includes a second fastener configured to receive the first fastener to secure the first support member to the first rail.

6. The modular display of claim 2, the second rail comprising a front wall, a bottom wall, and a rear wall, the rear wall being closer to the first rail than the front wall, wherein a platform projects outwards from the front wall towards the rear wall, and wherein an overhang projects outwards from the rear wall in the first direction towards the front wall.

7. The modular display of claim 6, wherein a vertical gap is provided between the platform and the overhang.

8. The modular display of claim 7, wherein the platform and the overhang do not overlap in a vertical direction.

9. The modular display of claim 6, wherein the hanger rests on the platform, and wherein the overhang overlaps a portion of the hanger in a vertical direction.

10. The modular display of claim 1, the frame further comprising a third rail spaced from the first rail and aligned therewith in a vertical direction, wherein the first, second, and third rails extend between a pair of side brackets in the second direction.

11. The modular display of claim 10, further comprising a second support member removably supported by and slidable along the frame, the second support member comprising:
a hanger supported by the second rail;
a first pair of slides spaced apart from one another in the second direction, wherein a first tail is provided at an end of the first pair of slides, and wherein the first tail is supported by the first rail; and
a second pair of slides spaced apart from one another in the second direction, wherein a second tail is provided at an end of the second pair of slides, and wherein the second tail is supported by the third rail.

12. The modular display of claim 11, wherein the second pair of slides is disposed beneath the first pair of slides.

13. The modular display of claim 1, further comprising a towing ball mount arrangement as one of said tow hitch products, the towing ball mount arrangement comprising:
a mounting tube;
a locking pin disposed adjacent said mounting tube; and
a clamp removably attached to the mounting tube and securing the locking pin to the mounting tube.

14. The modular display of claim 13, wherein the clamp comprises first and second legs secured to one another at a common junction, wherein each of the first and second legs includes a protrusion projecting outwards therefrom, and wherein each protrusion is supported on a corresponding one of the pair of slides of the first support member.

15. The modular display of claim 1, wherein the pair of slides are configured to support the tow hitch products in a gravity-fed manor.

16. The modular display of claim 1, wherein each slide of the pair of slides extends between opposite first and second ends, wherein a stop is formed at each first end of the pair of slides, and wherein the stops are configured to prohibit dislodgement of the tow hitch products from the pair of slides.

17. The modular display of claim 1, wherein each slide of the pair of slides is angled relative to an imaginary horizontal plane that is coterminous with a corresponding front end thereof.

18. The modular display of claim 17, wherein a distance between each slide and the imaginary horizontal plane continuously increases at successive points there along in a direction from the first end of the corresponding slide towards an opposite, second end of the corresponding slide.

19. A modular display for merchandising and displaying tow hitch products, the display comprising:
a frame having a first rail, a second rail, and a pair of side brackets, each of the first and second rails extending between the pair of side brackets in a first direction, wherein the second rail is spaced from the first rail in a second direction, perpendicular to the first direction; and
a first support member removably supported by and slidable along the frame, the first support member comprising:
a tail supported by the first rail;
a hanger supported by the second rail; and
a pair of slides spaced apart from one another in the first direction, wherein the pair of slides are configured to support the tow hitch products thereon,
wherein each slide of the pair of slides is angled relative to an imaginary horizontal plane that is coterminous with a corresponding front end thereof, and wherein a distance between each slide and the imaginary horizontal plane increases at successive points there along in a direction from the first end of the corresponding slide towards an opposite, second end of the corresponding slide, wherein the second end of the corresponding slide is disposed closer to the tail than the first end of the corresponding slide.

20. The modular display of claim 19, the first rail comprising a top wall and a bottom wall, wherein each of the top wall and the bottom wall has a slot formed therein, wherein the slot formed in the top wall and the slot formed in the bottom wall are coaxial and are configured to receive a first fastener therein, wherein the second rail comprises a front wall, a bottom wall, and a rear wall, the rear wall of the second rail being closer to the first rail than the front wall of the second rail, wherein a platform projects outwards from the front wall of the second rail towards the rear wall of the second rail, and wherein an overhang projects outwards from the rear wall of the second rail in the first direction towards the front wall of the second rail, wherein a vertical gap is provided between the platform and the overhang, wherein the hanger rests on the platform, and wherein the overhang overlaps a portion of the hanger in a vertical direction.
